(19) United States
(12) Patent Application Publication
(10) Pub. No.: US 2016/0173193 A1
(43) Pub. Date: Jun. 16, 2016

(54) SYSTEM AND METHOD FOR INTERCONNECTING OBJECTS WITH OPTICAL FIBERS

(71) Applicant: TYCO ELECTRONICS (SHANGHAI) CO. LTD., Shanghai (CN)

(72) Inventors: Huaisheng ZHU, Shanghai (CN); Zhaoyang TONG, Shanghai (CN); Weili ZHANG, Shanghai (CN)

(21) Appl. No.: 14/906,146

(22) PCT Filed: Jul. 11, 2014
(86) PCT No.: PCT/IB2014/063028

§ 371 Date: Jan. 19, 2016

(30) Foreign Application Priority Data
Jul. 19, 2013 (CN) 201310306239.7

(51) Int. Cl. H04B 10/07; H04Q 11/00; H04Q 1/02

(52) U.S. Cl. CPC H04B 10/07; H04Q 1/138; H04Q 11/0003

(57) ABSTRACT

A system for interconnecting at least a pair of objects with optical fibers, comprising: optical fibers each having a first end provided with a first tag and a second end provided with a second tag, the optical fibers each is disposed between a pair of objects with the first end near one of the pair of objects and the second end near the other of the pair of objects; a plurality of readers for reading the matching codes from the tags of the optical fibers inserted into respective ports; a plurality of indicators for indicating state of respective ports; and a server management device for processing data read from the objects and controlling the states of the indicators. Before inserting the optical fiber, the server management device builds up a correct one-to-one correlation among the ports of the pair of objects and controls all ports to switch into a first indication state; operations of randomly inserting the ends of the optical fibers into the ports are performed simultaneously.

### CROSS-REFERENCE TO RELATED APPLICATION

This application claims the benefit of Chinese Patent Application No. 201310306239.7 filed on Jul. 19, 2013 in the State Intellectual Property Office of China, the whole disclosure of which is incorporated herein by reference.

### BACKGROUND OF THE INVENTION

1. Field of the Invention

Embodiments of the present invention relates to a system and a method for correctly interconnecting objects or modules of the same object with optical fibers, more particularly, relates to a system and a method for intelligently and correctly connecting optical fibers, for example, connecting distribution fibers of optical fiber distributing equipments, in quantities.

2. Description of the Related Art

In the prior art, during connecting optical fibers in an optical fiber distribution system, the optical fibers are identified depended on serial numbers on tags adhered to the optical fibers or serial numbers printed on the optical fibers. Also, ports to be connected with the optical fibers are identified depended on serial numbers on tags adhered to the ports or serial numbers printed on the ports. In some conditions, there may be no serial number on the ports, and the ports are identified depended on only the order of arranging them.

Accordingly, in practice, for finishing a connection operation of optical fibers, an operator has to perform the following steps of: firstly, looking up a fiber-port distribution table; secondly, visually identifying serial numbers of optical fibers; and finally, looking for ports corresponding to the optical fibers based on the table and correctly inserting the optical fibers into the respective ports. During each of the above steps, it needs the operator to carefully identifying the serial numbers, causing the vision tiredness of the operator. In a situation, the serial numbers may become blurred or damaged due to the severe application condition and may be illegible for the operator. Also, lighting in the operation field may disadvantageously affect the operator to identify and determine the serial numbers. Furthermore, it is difficult for the operator to find a misconnection of the optical fibers in the field, and the operator cannot find the misconnection in time. Also, the operator encounters the above difficulties again during performing the maintenance for the optical fiber.

An identification device adopting Radio Frequency Identification (RFID) technology, as a wireless communication technology, can identify specific targets and read and write data correlated to the specific targets with wireless communication signals. As a result, it is not necessary to build up a physical electrical or optical connection between the identification device and the specific targets. The RFID identification device has a reader. The reader can transmit a wireless electromagnetic field toward the RFID tag adhered on the target, and the RFID identification device can identify the RFID tag depended on an interaction of the wireless electromagnetic field with the RFID tag, obtain the data from the RFID tag and transmit the data to a target device. In this way, the RFID identification device can automatically identify and track the physical position of the target. The RFID tag may be configured to get energy from the electromagnetic field transmitted from the reader and does not have a battery therein. Otherwise, the RFID tag may be provided with a power source therein and can actively transmit a radio wave (which can be adjusted to the electromagnetic field). The RFID contains data electronically stored therein, and the reliable identification distance for the RFID may be up to several meters. The RFID tag is different from a bar code tag because the RFID can be not only provided on a surface of the target to be identified/tracked, but also embedded inside the target to be identified/tracked.

### SUMMARY OF THE INVENTION

The present invention has been made to overcome or alleviate at least one aspect of the above mentioned disadvantages.

Accordingly, it is an object of the present invention to provide a system and a method for intelligently and correctly connecting optical fibers between objects or modules of the same object in quantities, without a need to look up a fiber-port distribution table and identify serial numbers of optical fibers and ports in advance. With the system and the method of embodiments of the present invention, the ports of objects can be quickly and correctly interconnected in a manner of blind plug installation.

Furthermore, the system and the method according to another aspect of the present invention can permit two operators at a pair of objects to be interconnected to simultaneously insert ends of the optical fibers into ports of the pair of objects, doubling the installation speed.

According to an aspect of the present invention, there is provided a system for interconnecting at least a pair of objects by optical fibers, comprising:

optical fibers each having a first end provided with a first tag and a second end provided with a second tag, wherein the first and second tags of each optical fiber contain an unique and the same matching code or different but correlated matching codes, the optical fibers each is disposed between a pair of objects with the first end near one of the pair of objects and the second end near the other of the pair of objects, the first end of the optical fiber is to be inserted into the port of the one object, and the second end of the optical fiber is to be inserted into the port of the other object;

a plurality of readers provided at a plurality of ports of each object to be connected by the optical fibers, respectively, for reading the matching codes from the tags of the optical fibers inserted into respective ports;

a plurality of indicators provided at the plurality of ports of each object to be connected by the optical fibers, respectively, for indicating states of respective ports; and

a server management device for processing data read from the objects and controlling the states of the indicators, wherein

before inserting the optical fiber, the server management device builds up a correct one-to-one correlation among the ports of the pair of objects to be interconnected and controls all ports of the pair of objects to switch into a first indication state;

operations of randomly inserting the ends of the optical fibers into the ports of the pair of objects to be interconnected are performed simultaneously at the pair of objects,

the optical fiber is firstly randomly inserted into the port having the first indication state, and the server management device obtains the matching code of the tag of the current inserted optical fiber through the reader corresponding to the current connected port, correlates the current obtained matching code to the current connected port and another port to be correctly connected with the current connected port, and controls the indicators of the current connected port and the another port correlated to the current obtained matching code to switch into a second indication state,

when the pair of objects neither have the port having the first indication state, the optical fiber is randomly inserted into the port having the second indication state, and the server management device obtains the matching code of the tag of the current inserted optical fiber through the reader corresponding to the current connected port, and determines whether the current connected port is the port correlated to the matching code of the current inserted optical fiber,

if the current connected port is not the port correlated to the matching code of the current inserted fiber, the server management device controls the indicator of the current connected port to switch into a third indication state, and controls the indicator of the port correlated to the matching code of the current inserted optical fiber to switch into a fourth indication state, so as to guide an operator to pull the current inserted optical fiber out of the current connected port and insert the current pulled optical fiber into the port having the fourth indication state,

when the second end of the optical fiber whose first end has been inserted into the port having the first indication state of the one object is inserted into the port having the first indication state of the other object, the server management device obtains the matching code of the tag of the second end of the current inserted optical fiber through the reader corresponding to the current connected port of the other object, and

if the server management device determines that the matching code of the current inserted optical fiber has been correlated to another port of the other object and the current connected port of the other object has not been correlated to any matching code of any optical fiber, then the server management device controls the indicator of the current connected port of the other object to switch into the third indication state, and controls the indicator of the port of the other object correlated to the matching code of the current inserted optical fiber to switch into the fourth indication state, so as to guide the operator to pull the current inserted fiber out of the current connected port of the other object and insert the current pulled optical fiber into the port having the fourth indication state of the other object, and controls the indicator of the port, from which the optical fiber has been just pulled, to switch into the first indication state again,

the first, second, third and fourth indication states are different from each other.

According to an exemplary embodiment of the present invention, when the second end of the optical fiber whose first end has been inserted into the port of the one object is correctly inserted into the port of the other object correlated to the matching code of the current inserted optical fiber, the server management device controls the current connected port of the other object to switch into the second indication state, and turns off the indicators of the pair of current ports correctly connected after a predetermined period.

According to another exemplary embodiment of the present invention, in a case where a first end of a current optical fiber has been inserted into a third object which is not any one of the pair of objects to be interconnected, when a second end of the current optical fiber is randomly inserted into one of the ports of the other object of the pair of objects to be interconnected, the server management device controls the indicator of the current port of the other object to switch into the third indication state, and controls indicators of all empty ports of the other object to switch into the second indication state, so as to notice the operator that the current optical fiber has been inserted into the third object, that is not any one of the pair of objects to be interconnected, and should be removed from the other object of the pair of objects to be interconnected.

According to another exemplary embodiment of the present invention, when two or more fibers are incorrectly inserted into two or more ports of one of the pair of objects to be connected, the server management device controls indicators of the two or more ports of the object to switch into a third indication state, and controls all empty ports of the object to switch into the second indication state, so as to notice the operator to remove the two or more fibers from the object until only one of the two or more fibers is left, and when only one of the two or more fibers is left, the server management device controls the indicator of the port of the object correlated to the matching code of the left one fiber to switch into the fourth indication state, so as to guide the operator to correctly insert the left one fiber into the port of the object having the fourth indication state.

According to another exemplary embodiment of the present invention, the indicator comprises a lamp, a display, a sounder, a vibrator, or combination thereof.

According to another exemplary embodiment of the present invention, the indicator comprises a LED lamp.

According to another exemplary embodiment of the present invention, the first indication state is a state selected from a slow flashing state, a quick flashing state having a frequency higher than that of the slow flashing state, a quick-slow flashing state having a frequency equal to that of the slow flashing state in one half period and a frequency equal to that of the quick flashing state in the other half period, and a normally lighting state; the second indication state is a state, different from the first indication state, selected from the slow flashing state, the quick flashing state, the quick-slow flashing state, and the normally lighting state; the third indication state is a state, different from the first and second indication states, selected from the slow flashing state, the quick flashing state, the quick-slow flashing state, and the normally lighting state; and the fourth indication state is a state, different from the first, second and third indication states, selected from the slow flashing state, the quick flashing state, the quick-slow flashing state, and the normally lighting state.

According to another exemplary embodiment of the present invention, the first indication state is the slow flashing state, the second indication state is the normally lighting state, the third indication state is the quick flashing state, and the fourth indication state is the quick-slow flashing state.

According to another exemplary embodiment of the present invention, the pair of objects to be interconnected are disposed such that a single operator cannot simultaneously perform the fiber insertion operation for the pair of objects.

According to another exemplary embodiment of the present invention, the pair of objects to be interconnected are disposed such that the single operator at one of the pair of objects cannot see or access the other one of the pair of objects.

According to another exemplary embodiment of the present invention, the pair of objects are disposed in different locations of a room, different rooms, different floors, different buildings, different residential areas, different streets, different cities or different countries.

According to another exemplary embodiment of the present invention, each of tags further contains a unique identification code for differentiating respective tags.

According to another exemplary embodiment of the present invention, the server management device comprises only a central processing unit communicated with all objects to be interconnected.

According to another exemplary embodiment of the present invention, the server management device comprising: a central processing unit; and a single-stage or a multi-stage secondary processing unit communicated between the central processing unit and the respective objects, for monitoring the connection state of the ports and controlling the indication state of the indicators of the respective objects.

According to another exemplary embodiment of the present invention, the tag comprises a RFID tag.

According to another exemplary embodiment of the present invention, the objects comprise different equipments or different regions or modules on single equipment.

According to another exemplary embodiment of the present invention, the equipment comprises an optical fiber distributing equipment, and wherein the optical fiber comprises a distribution fiber for the optical fiber distributing equipment.

According to another exemplary embodiment of the present invention, at least one of the ports of at least one of the objects to be connected comprises a port of a portable electronic device communicated with the server management device in real time.

According to another aspect of the present invention, there is provided a method for interconnecting at least a pair of objects with optical fibers, comprising:

S100: providing a system for interconnecting objects with optical fibers, the system comprising:
optical fibers each having a first end provided with a first tag and a second end provided with a second tag, wherein the first and second tags of each optical fiber contain an unique and the same matching code or different but correlated matching codes, the optical fibers each is disposed between a pair of objects with the first end near one of the pair of objects and the second end near the other of the pair of objects, the first end of the optical fiber is to be inserted into the port of the one object, and the second end of the optical fiber is to be inserted into the port of the other object;
a plurality of readers provided at a plurality of ports of each object to be connected by the optical fibers, respectively, for reading the matching codes from the tags of the optical fibers inserted into respective ports;
a plurality of indicators provided at the plurality of ports of each object to be connected by the optical fibers, respectively, for indicating states of respective ports; and
a server management device for processing data read from the objects and controlling the states of the indicators;

S200: before inserting the optical fiber, the server management device builds up a correct one-to-one correlation among the ports of the pair of objects to be interconnected and controls all ports of the pair of objects to switch into a first indication state;

S300: at the pair of objects, simultaneously performing operations of randomly inserting the ends of the optical fibers into the ports of the pair of objects to be interconnected, wherein

the optical fiber is firstly randomly inserted into the port having the first indication state, and the server management device obtains the matching code of the tag of the current inserted optical fiber through the reader corresponding to the current connected port, correlates the current obtained matching code to the current connected port and another port to be correctly connected with the current connected port, and controls the indicators of the current connected port and the another port correlated to the current obtained matching code to switch into a second indication state,

when the pair of objects neither have the port having the first indication state, the optical fiber is randomly inserted into the port having the second indication state, and the server management device obtains the matching code of the tag of the current inserted optical fiber through the reader corresponding to the current connected port, and determines whether the current connected port is the port correlated to the matching code of the current inserted optical fiber,
if the current connected port is not the port correlated to the matching code of the current inserted fiber, the server management device controls the indicator of the current connected port to switch into a third indication state, and controls the indicator of the port correlated to the matching code of the current inserted optical fiber to switch into a fourth indication state, so as to guide an operator to pull the current inserted optical fiber out of the current connected port and insert the current pulled optical fiber into the port having the fourth indication state,

when the second end of the optical fiber whose first end has been inserted into the port having the first indication state of the one object is inserted into the port having the first indication state of the other object, the server management device obtains the matching code of the tag of the second end of the current inserted optical fiber through the reader corresponding to the current connected port of the other object, and
if the server management device determines that the matching code of the current inserted optical fiber has been correlated to another port of the other object and the current connected port of the other object has not been correlated to any matching code of any optical fiber, then the server management device controls the indicator of the current connected port of the other object to switch into the third indication state, and controls the indicator of the port of the other object correlated to the matching code of the current inserted optical fiber to switch into the fourth indication state, so as to guide the operator to pull the current inserted fiber out of the current connected port of the other object and insert the current pulled optical fiber into the port having the fourth indication state of the other object, and controls the indicator of the port from which the optical fiber has been just pulled to switch into the first indication state again, and

the first, second, third and fourth indication states are different from each other.

In the above various embodiments of the present invention, the operator can easily and correctly interconnect respective ports of objects with optical fibers in the field according to the indication states of the indicators of the respective ports.

According to the exemplary embodiments of the present invention, there is provided a system and a method for intelligently and correctly connecting optical fibers in quantities on basis of the RFID technology. The system and the method can quickly connect the optical fibers between objects or modules of a single object regardless of the distance between the objects and can avoid the misconnection of the optical fibers. The system adopts a computer server management technology, a RFID technology and indications of LED lamps, and the operator can correctly connect the optical fibers to the ports in the field under the guidance of the indications of the LED lamps. Also, the system can monitor the connection state of the respective ports in real time and provide a report related to this.

The system can ensure the operator to correctly connect the optical fibers to the ports in the field, remarkably improving the connection efficiency, and eliminating the misconnection and reconnection for overcoming the misconnection. Similarly, the operator can perform the maintenance under the guidance of indications of the LED lamps.

However, the connection system or method in prior art lacks the above features of the present invention, and the operator must visually identify the optical fibers and the ports in the field fully depended on serial numbers on the optical fibers and ports, it consumes much time. Furthermore, in prior art, it likely results the misconnection, and the misconnection cannot be easily found in time by the operator. Also, in the prior art, the maintenance is very inconvenient. In sum, in prior art, the connection and maintenance has disadvantages of low efficiency and high cost.

In the system according to the above embodiments of the present invention, first and second ends of optical fibers can be correctly connected to the respective ports of a pair of objects only under the guidance of indications of the LED lamps without a need to look up a fiber-port distribution table and identify serial numbers of optical fibers and ports in advance. With the system and the method of the exemplary embodiments of the present invention, the ports of objects can be quickly and correctly interconnected in a manner of blind plug installation. Furthermore, it permits two operators at the pair of objects to simultaneously insert the ends of the optical fibers into the ports of the pair of objects, doubling the installation speed.

In the system according to the exemplary embodiments of the present invention, the first and second ends of each optical fiber are provided with a first RFID tag and a second RFID tag, and the two RFID tags of each optical fiber contain an unique and the same matching code or different but correlated matching codes. Also, the two RFID tags of each optical fiber may contain a unique identification code. Also, near each of the ports of the object is provided a RFID tag identification antenna to read the matching code and the identification code from the RFID tag. Also, near each of the ports is provided a LED lamp to indicate the state of the respective port, and the LED lamp is controlled to have different indications corresponding to different operations for the respective port. Also, the system may comprise a server to process the data read from the objects and control the indications of the LED lamps. Furthermore, a single-stage or a multi-stage secondary processing unit communicated between the server and the objects may be provided, for monitoring the connection state of the ports and controlling the indications of the LED lamps of the objects.

According to the above various exemplary embodiments of the present invention, the operators firstly insert the first and second ends of the optical fibers into the ports having the first indication state of the pair of objects in the manner of blind plug installation, without the need to identify serial numbers of optical fibers and ports. However, after all ports having the first indication state of the pair of objects have been connected, the operators have to insert the first and second ends of the optical fibers into the ports having an indication state different from the first indication state under the guidance of the indications of the indicators, instead of in the manner of blind plug installation.

### BRIEF DESCRIPTION OF THE DRAWINGS

The above and other features of the present invention will become more apparent by describing in detail exemplary embodiments thereof with reference to the accompanying drawings, in which:

FIG. 1 is a principle block diagram of a system for interconnecting objects with optical fibers according to an exemplary embodiment of the present invention;

FIG. 2 is an illustrative view showing an example to build up a correct one-to-one correlation among the ports of a pair of objects A, B of FIG. 1 to be interconnected;

FIG. 3 is an illustrative view showing an example of correlating a matching code of a current optical fiber randomly inserted into a current port of the object A of FIG. 1 to the current port of the object A and a port of the other object B to be correctly interconnected with the current port of the object A; and

FIG. 4 is a basic control flow chart for building up a correct fiber interconnection among ports of a pair of objects A, B, in which many kinds of error management flows are shown.

### DETAILED DESCRIPTION OF PREFERRED EMBODIMENTS OF THE IVENTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

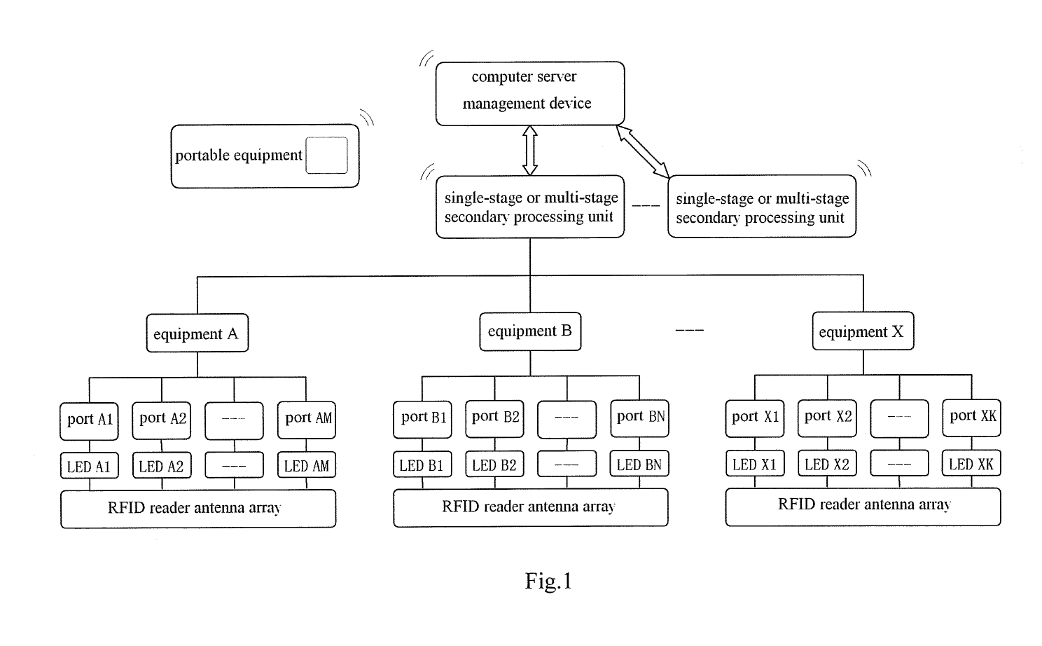

FIG. 1 is a principle block diagram of a system for interconnecting objects with optical fibers according to an exemplary embodiment of the present invention.

As shown in FIG. 1, in the illustrated embodiment, the system for interconnecting objects with optical fibers mainly comprises a plurality of equipments (also referred as objects herein), for example, an equipment A, an equipment B, . . . , and an equipment X.

As shown in FIG. 1, each of the equipments A, B, . . . , and X has a plurality of ports to be connected with optical fibers, and these ports may be arranged in an array. For example, in the illustrated embodiment, the equipment A has a port A1, a port A2, . . . , and a port AM (M is an integer larger than 2); the equipment B has a port B1, a port B2, . . . , and a port BN (N is an integer larger than 2); the equipment X has a port X1, a port X2, . . . , and a port XK (K is an integer larger than 2).

In application, it is necessary to build up a fiber interconnection between two or more equipments of a fiber distribution system as necessary. Accordingly, the embodiments of the present invention provide the system for correctly and quickly interconnecting equipments with optical fibers.

In an exemplary embodiment of the present invention, a pair of objects to be interconnected may be provided such that a single operator at one of the pair of objects cannot see or access the other one of the pair of objects. For example, the pair of objects may be disposed in different locations of a room, different rooms, different floors, different buildings, different residential areas, different streets, different cities, different countries or the like. In some conditions, since a distance between the pair of objects is very long, for example, several meters to thousands of kilometers, a single operator cannot simultaneously perform the installation of the pair of objects. In this case, in order to rapidly install the pair of objects, it needs to simultaneously insert first and second ends of the optical fibers into the ports of the pair of objects in a manner of blind plug installation. For example, in order to improve the installation efficiency, two operators at the pair of objects may simultaneously insert the first and second ends of the optical fibers into the ports of the pair of objects in the manner of blind plug installation, without a need to look up a fiber-port distribution table and identify serial numbers of optical fibers and ports in advance.

Please be noted that the present invention is not limited to the illustrated embodiments, for example, the system of the present invention also can be used to interconnect different regions or modules (also referred as objects herein) on the same equipment with optical fibers. In an exemplary embodiment, the same equipment has two or more different regions or modules each having a plurality of ports to be interconnected with optical fibers, and these ports may be arranged in an array in the region or module.

The system according to the exemplary embodiment of the present invention mainly comprising: optical fibers each having a first end provided with a first tag and a second end provided with a second tag, wherein the first and second tags of each optical fiber contain an unique and the same matching code or different but correlated matching codes, the optical fibers each is disposed between a pair of objects with the first end near one of the pair of objects and the second end near the other of the pair of objects, the first end of the optical fiber is to be inserted into the port of the one object, and the second end of the optical fiber is to be inserted into the port of the other object; a plurality of readers provided at a plurality of ports of each object to be connected by the optical fibers, respectively, for reading the matching codes from the tags of the optical fibers to be inserted into respective ports; a plurality of indicators provided at the plurality of ports of each object to be connected by the optical fibers, respectively, for indicating states of respective ports; and a server management device for processing data read from the objects and controlling the states of the indicators.

In the exemplary embodiment shown in FIG. 1, each of two ends of each of optical fibers is provided with a RFID tag, and two RFID tags of each optical fiber contain an unique and the same matching code.

But the present invention is not limited to this, the two RFID tags of each optical fiber may contain different but correlated matching codes. For example, a first RFID tag at a first end of an optical fiber may contain a matching code ‘C1A’, and a second RFID tag at a second end of the optical fiber may contain a matching code ‘C1B’. In this way, the two matching codes of the two RFID tags of the optical fiber can be correctly correlated to each other by means of a common section ‘C1’ of the two matching codes ‘C1A’ and ‘C1B’. In addition, the first end and the second end of the optical fiber may be identified based on different sections ‘A’ and ‘B’ of the two matching codes ‘C1A’ and ‘C1B’, respectively.

In an exemplary embodiment of the present invention, each of tags may also contain an unique identification code for differentiating respective tags.

In the exemplary embodiment shown in FIG. 1, at each of the ports (also referred as first ports herein) of the equipment A to be connected is provided a corresponding RFID reader antenna, for reading the matching code of the RFID tag of the optical fiber inserted into the first port. The RFID reader antennas may be arranged in an array as the first ports to be connected. Also, at each of the first ports of the equipment A to be connected is provided a corresponding LED indicator LEDA1, LEDA2, . . . , or LEDAM, for indicating the state of the respective first port.

Similarly, in the exemplary embodiment shown in FIG. 1, at each of the ports (also referred as second ports herein) of the equipment B to be connected is provided a corresponding RFID reader antenna, for reading the matching code of the RFID tag of the optical fiber inserted into the second port. The RFID reader antennas may be arranged in an array as the second ports to be connected. Also, at each of the second ports of the equipment B to be connected is provided a corresponding LED indicator LEDB1, LEDB2, . . . , or LEDBN, for indicating the state of the respective second port.

Similarly, in the exemplary embodiment shown in FIG. 1, at each of the ports (also referred as Xth ports herein) of the equipment X to be connected is provided a corresponding RFID reader antenna, for reading the matching code of the RFID tag of the optical fiber inserted into the Xth port. The RFID reader antennas may be arranged in an array as the Xth ports to be connected. Also, at each of the Xth ports of the equipment X to be connected is provided a corresponding LED indicator LEDX1, LEDX2, . . . , or LEDXK, for indicating the state of the respective Xth port.

Although the RFID tag is used as the tag of the optical fiber in the exemplary embodiment shown in FIG. 1, the present invention is not limited to this, the tag of the optical fiber may be taken the form of a bar code, a digital mark, an image mark, or any other suitable tag adhered or printed to the ends of optical fiber as long as these tags can be automatically read by an electrical apparatus. Correspondingly, the reader in the system of the present invention is not limited to the RFID reader antenna shown in FIG. 1, the reader may be taken the form of a bar code reader, a digital mark reader, an image mark reader, or any other suitable tag reader as long as these readers can automatically read data from the tags.

Although the LED lamp is used as the indicator in the exemplary embodiment shown in FIG. 1, but the present invention is not limited to this, the indicator may be a display, a sounder, a vibrator, or combination thereof. In this way, the operator can correctly insert the optical fiber into the port under visual, auditory or tactile guidance.

Referring to FIG. 1 again, in the illustrated embodiment, the computer server management device is used as the central processing unit for processing data read from the respective equipments and controlling the indication states of the respective indicators.

As shown in FIG. 1, in addition to the central processing unit, the system according to the exemplary embodiment of the present invention may further comprise a single-stage or a multi-stage secondary processing unit communicated between the central processing unit and the respective equipments, for monitoring the connection state of the ports and controlling the indication states of the indicators of the respective equipments.

Please be noted that the present invention is not limited to the exemplary embodiments shown in FIG. 1, the secondary processing unit may be omitted. That is, the system of the present invention may comprise only the central processing unit communicated with all equipments to be interconnected and not comprise any secondary processing unit.

In an exemplary embodiment of the present invention, the ports of each of the equipments to be connected may comprise a port of a portable electronic device communicated with the server management device in real time. For example, as shown in FIG. 1, the ports of each of the equipments to be connected may comprise a port of a mobile electronic equipment, for example, a portable reader, electrically communicated with the server management device in real time. In the illustrated embodiment, the portable electronic device is configured so that the operator in the field can rapidly identify the optical fiber to be inserted and install the optical fiber under guidance of the server management device. For example, the operator in the field may firstly insert the end of the optical fiber into the port of the portable electronic device and identify the matching code and the correct port currently to be connected under the guidance of the indications of the indicators, for example, a LED lump. In another exemplary embodiment, the portable electronic device may be used to increase the number of the ports of the equipment to be connected as necessary. The portable electronic device may be directly or indirectly communicated with the server management device.

Hereafter, it will describe in detail the system for interconnecting objects with optical fibers according to the exemplary embodiment of the present invention by taking the process of building up a fiber interconnection between the equipment A and the equipment B as an example.

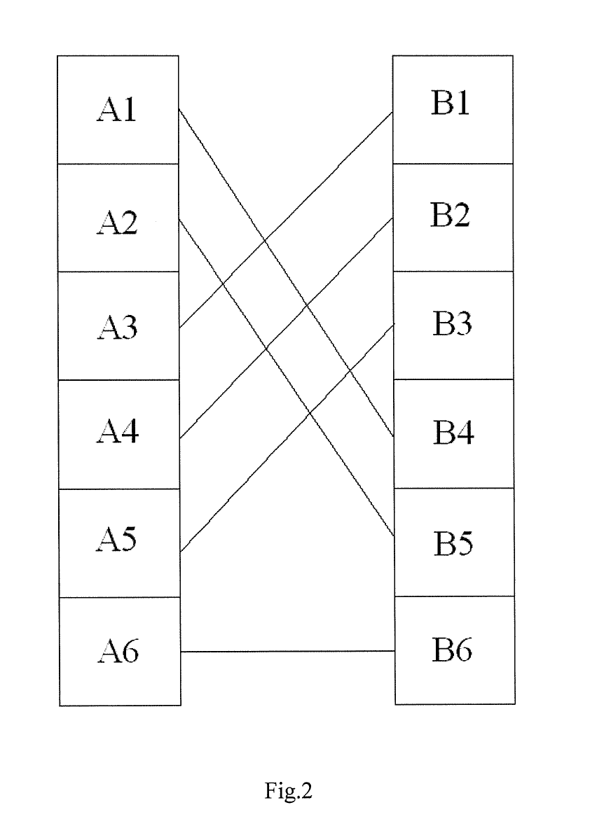

Firstly, before inserting the optical fiber, according to the practical requirement, the central processing unit builds up a task form comprising a correct one-to-one correlation among the ports of the pair of equipments A and B to be interconnected. For example, as shown in FIG. 2, it is assumed that the ports of the equipment A to be connected comprise port A1, port A2, port A3, port A4, port A5 and port A6, and it is assumed that the ports of the equipment B to be connected comprise port B1, port B2, port B3, port B4, port B5 and port B6. Furthermore, according to the practical requirement, as shown in FIG. 2, it is assumed that the correct one-to-one correlation among the ports of the pair of equipments A and B is as follows: the port A1 of the equipment A should be connected to the port B4 of the equipment B, the port A2 of the equipment A should be connected to the port B5 of the equipment B, the port A3 of the equipment A should be connected to the port B1 of the equipment B, the port A4 of the equipment A should be connected to the port B2 of the equipment B, the port A5 of the equipment A should be connected to the port B3 of the equipment B, and the port A6 of the equipment A should be connected to the port B6 of the equipment B.

After the central processing unit builds up the task form, the server management device controls all indicators of respective ports of the equipments A and B to be connected to switch into a first indication state and repeatedly scans a connection state of the respective ports of the equipments A and B. In an exemplary embodiment of the present invention, the first indication state may comprise a slow flashing state.

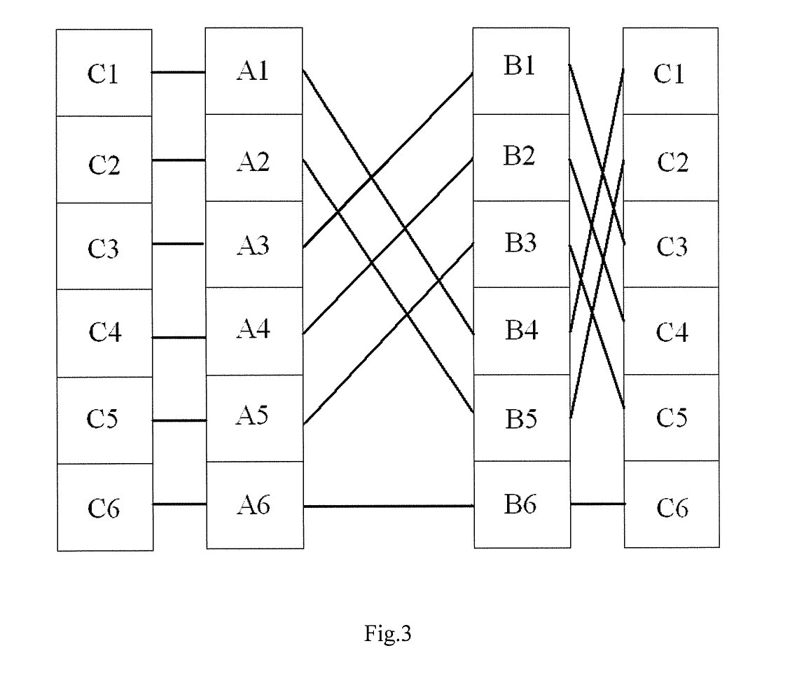

Then, one operator at the equipment A and the other operator at the equipment B simultaneously insert the ends of the optical fibers into the ports having the first indication state of the equipments A and B, instead of starting the installation of the other of the pair of equipments after the installation of one of the pair of equipments has been finished. As a result, the present invention can increase the installation speed. For example, the one operator at the equipment A may select any one from the optical fibers and randomly insert the first end of the selected optical fiber into any one port having the first indication state of the equipment A, for example, the first end of the selected optical fiber is inserted into the port A1 of the equipment A, at this time, the server management device obtains the matching code C1 (please see FIG. 3) of the tag of the current inserted optical fiber through the reader corresponding to the current connected port, correlates the current obtained matching code C1 to the current connected port A1 and another port B4 to be correctly connected with the current connected port, controls the indicator LEDA1 of the port A1 to change into a second indication state different from the first indication state, and controls the indicator corresponding to the port B4 of the other equipment B correlated to the matching code C1 of the current optical fiber to change into the second indication state. In an exemplary embodiment of the present invention, the second indication state may comprise a normally lighting state.

At the same time when the one operator at the equipment A inserts the ends of the optical fibers into the ports having the first indication state of the equipment A, the other operator at the equipment B may select any one from the optical fibers and randomly insert the second end of the selected optical fiber into any one port having the first indication state of the equipment B, for example, the second end of the selected optical fiber is inserted into the port B6 of the equipment B, at this time, the server management device obtains the matching code C6 (please see FIG. 3) of the tag of the current inserted optical fiber through the reader corresponding to the current connected port, correlates the current obtained matching code C6 to the current connected port B6 and another port A6 to be correctly connected with the current connected port, controls the indicator LEDB6 of the port B6 change into the second indication state different from the first indication state, and controls the indicator corresponding to the port A6 of the equipment A correlated to the matching code C6 of the current optical fiber to change into the second indication state. The second indication state may comprise a normally lighting state.

The one operator at the equipment A may randomly insert the first ends of the optical fibers into the ports having the first indication state of the equipment A until the equipment A does not have the port having the first indication state. Similarly, at the same time, the other operator at the equipment B may randomly insert the second ends of the optical fibers into the ports having the first indication state of the equipment B until the equipment B does not have the port having the first indication state.

For example, when the one operator at the equipment A inserts first ends of three optical fibers into the ports A1, A2, A3 having the first indication state of the equipment A, and when the other operator at the equipment B inserts second ends of three optical fibers into the ports B2, B3, B6 having the first indication state of the equipment B, the indicators of all ports A1, A2, A3, A4, A5, A6 of the equipment A and the indicators of all ports B1, B2, B3, B4, B5, B6 of the equipment B are all changed into the second indication state. At this time, the equipment A does not have the port having the first indication state, and the one operator at the equipment A may select any one of the rest optical fibers whose first ends are not connected and randomly insert the first end of the selected optical fiber into any one of the rest port which has the second indication state of the equipment A and is empty, and the server management device obtains the matching code of the tag of the current inserted optical fiber through the reader corresponding to the current connected port, and determines whether the current connected port is the port correlated to the matching code of the current inserted optical fiber, if the current connected port is not the port correlated to the matching code of the current inserted fiber, the server management device controls the indicator of the current connected port to switch into a third indication state, and controls the indicator of the port correlated to the matching code of the current inserted optical fiber to switch into a fourth indication state, so as to guide the one operator at the equipment A to pull the current inserted optical fiber out of the current connected port and insert the current pulled optical fiber into the port having the fourth indication state of the equipment A. Once the current pulled optical fiber is inserted into the port having the fourth indication state of the equipment A, the server management device controls the indicator of the current connected port of the equipment A to switch into the second indication state, and turns off the indicators of the current pair of ports that have been correctly connected after a predetermined period, for example, 3 seconds.

Similarly, when the equipment B does not have the port having the first indication state, and the other operator at the equipment B may select any one of the rest optical fibers whose second ends are not connected and randomly insert the second end of the selected optical fiber into any one of the rest port which has the second indication state of the equipment B and is empty, and the server management device obtains the matching code of the tag of the current inserted optical fiber through the reader corresponding to the current connected port, and determines whether the current connected port is the port correlated to the matching code of the current inserted optical fiber, if the current connected port is not the port correlated to the matching code of the current inserted fiber, the server management device controls the indicator of the current connected port to switch into the third indication state, and controls the indicator of the port correlated to the matching code of the current inserted optical fiber to switch into the fourth indication state, so as to guide the other operator at the equipment B to pull the current inserted optical fiber out of the current connected port and insert the current pulled optical fiber into the port having the fourth indication state of the equipment B. Once the current pulled optical fiber is inserted into the port having the fourth indication state of the equipment B, the server management device controls the indicator of the current connected port of the equipment B to switch into the second indication state, and turns off the indicators of the current pair of ports that have been correctly connected after a predetermined period, for example, 3 seconds.

In an exemplary embodiment of the present invention, the third indication state is different from the first indication state, the second indication state and the fourth indication state. For example, the third indication state may comprise a quick flashing state having a frequency higher than that of the slow flashing state, for alerting the misconnection. In an exemplary embodiment of the present invention, the fourth indication state is different from the first indication state, the second indication state and the third indication state. For example, the fourth indication state may comprise a quick-slow flashing state having a frequency equal to that of the slow flashing state in one half period and a frequency equal to that of the quick flashing state in the other half period.

During the one operator at the equipment A and the other operator at the equipment B simultaneously insert the ends of the optical fibers into the ports having the first indication state of the equipments A and B in the manner of blind plug installation, the indicators of the ports of the equipments A and B may be changed into the third indication state or the fourth indication state. For example, the one operator at the equipment A inserts first ends of two optical fibers into the ports A1, A2 having the first indication state of the equipment A, and it is assumed that the optical fiber connected to the port A1 has the matching code C1, and the optical fiber connected to the port A2 has the matching code C2. At the same time, if the other operator at the equipment B takes the optical fiber (having the matching code C1) whose first end has been inserted into the port A1 of the equipment A and inserts the second end of the optical fiber having the matching code C1 into the port B1 having the first indication state of the equipment B, at this time, the server management device obtains the matching code C1 of the tag of the current inserted optical fiber through the reader corresponding to the current connected port B1. If the server management device determines that the matching code C1 of the current inserted optical fiber has been correlated to the port B4 of the equipment B and that the current connected port B1 is not correlated to the matching code of any optical fiber, the server management device controls the indicator of the port B1 to switch into the third indication state, and controls the port B4 correlated to the matching code C1 of the current optical fiber to switch into the fourth indication state, so as to guide the other operator at the equipment B to pull the current inserted optical fiber out of the current connected port B1 and insert the current pulled optical fiber having the matching code C1 into the port B4 having the fourth indication state of the equipment B. Once the current pulled optical fiber having the matching code C1 is inserted into the port B4 having the fourth indication state of the equipment B, the server management device controls the indicator of the current connected port B4 of the equipment B to switch into the second indication state, and turns off the indicators of the pair of ports A1 and B4 that have been correctly connected after a predetermined period, for example, 3 seconds. In addition, after the optical fiber having the matching code C1 is pulled out of the port B1, the indicator of the port B1 is changed into the first indication state because the port B1 is not correlated to the matching code of any optical fiber and is changed into empty state.

In an exemplary embodiment shown in FIG. 3, the matching code C1 is correlated to the port A1 of the equipment A and the port B4 of the equipment B, the matching code C2 is correlated to the port A2 of the equipment A and the port B5 of the equipment B, the matching code C3 is correlated to the port A3 of the equipment A and the port B1 of the equipment B, the matching code C4 is correlated to the port A4 of the equipment A and the port B2 of the equipment B, the matching code C5 is correlated to the port A5 of the equipment A and the port B3 of the equipment B, and the matching code C6 is correlated to the port A6 of the equipment A and the port B6 of the equipment B.

In the above various exemplary embodiments of the present invention, the first, second, third and fourth indication states are different from each other. For example, the first, second, third and fourth indication states are defined as follows.

The first indication state, exhibited as the slow flashing state, means that the corresponding port neither is correlated to the matching code of the optical fiber nor connected with any optical fiber;

The second indication state, exhibited as the normally lighting state, means that the corresponding port is correlated to the matching code of the optical fiber.

The third indication state, exhibited as the quick flashing state, means that a mistaken connection is occurred and that the corresponding port is incorrectly connected with the optical fiber.

The fourth indication state, exhibited as the quick-slow flashing state, means that the optical fiber, which has been pulled out of the port having the quick flashing state, should be inserted into the port having the quick-slow flashing state.

In this way, the one operator at the equipment A and the other operator at the equipment B can correctly insert the ends of the optical fibers into the ports of the equipments A and B under the guidance of the indicators until all ports A1, A2, A3, A4, A5, A6, B1, B2, B3, B4, B5, B6 of the equipments A and B have been correctly inserted with optical fibers.

In the above described embodiment, although the fourth indication state is set to be the quick-slow flashing state different from the first, second and third indication states, the present invention is not limited to this, and the fourth indication state may be set to be any other suitable indication state, for example, a flashing state alternatively changing colors, that can be differentiated from the first, second and third indication states.

The system for interconnecting equipments with optical fibers according to the exemplary embodiment of the present invention also has an ability preventing error. Hereafter, it will still take the pair of equipments A and B as an example to describe the ability preventing error of the system. For example, in the case where a first end of a current optical fiber has been inserted into a third equipment which does not belong to any one of the pair of equipments A and B to be interconnected, when a second end of the current optical fiber is randomly inserted into one of the ports of the equipment B of the pair of equipments A and B, for example, inserted into the port B1 of the equipment B, the server management device obtains a matching code C0 of a tag of the error optical fiber through the reader corresponding to the current port B1, and looks up a port correlated to the matching code C0 from the task form as shown in FIG. 3. As a result, the server management device cannot find the port correlated to the matching code C0 from the task form as shown in FIG. 3, and the server management device can determine that the current optical fiber has been inserted into the third equipment that does not belong to any one of the pair of equipments A and B to be currently interconnected. In this case, the server management device controls the indicator of the current port B1 of the equipment B to switch into the third indication state different from the first and second indication states, and controls indicators of all empty ports B2, B3, B4, B5, B6 of the equipment B to switch into the second indication state, so as to notice the operator that the current optical fiber is an error optical fiber that has been inserted into the third equipment, which does not belong to any one of the pair of equipments to be currently interconnected, and should be removed from the port B1 of the equipment B.

Furthermore, the system for interconnecting equipments with optical fibers according to the exemplary embodiment of the present invention also has a further ability preventing error. Hereafter, it will still take the pair of equipments A and B as an example to describe the further ability preventing error of the system. When two or more fibers are incorrectly inserted into two or more ports of the equipment to be connected, for example, when two optical fibers, one of the two optical fibers has the matching code C1 and has been inserted into the port A1 of the equipment A, and the other has the matching code C2 and has been inserted into the port A2 of the equipment A, are incorrectly inserted into the port B1 and the port B2 of the other equipment B, respectively, the server management device controls indicators of the two ports B1 and B2 of the other equipment B to switch into the third indication state (for example, the quick flashing state), and controls all empty ports B3, B4, B5, B6 of the other equipment B to switch into the second indication state (for example, the normally lighting state), so as to notice the operator to remove the two fibers from the other equipment B until only one of the two optical fibers is left, for example, the optical fiber having the matching code C1 is removed from the port B1 of the equipment B, and only the optical fiber having the matching code C2 is left. In this case, when only the optical fiber having the matching code C2 is not removed and left, the server management device controls the indicator of the port B5 of the equipment B correlated to the matching code C2 of the left optical fiber to switch into the fourth indication state (for example, the quick-slow flashing state), so as to guide the operator to correctly insert the second end of the left optical fiber having the matching code C2 into the port B5 of the equipment B.

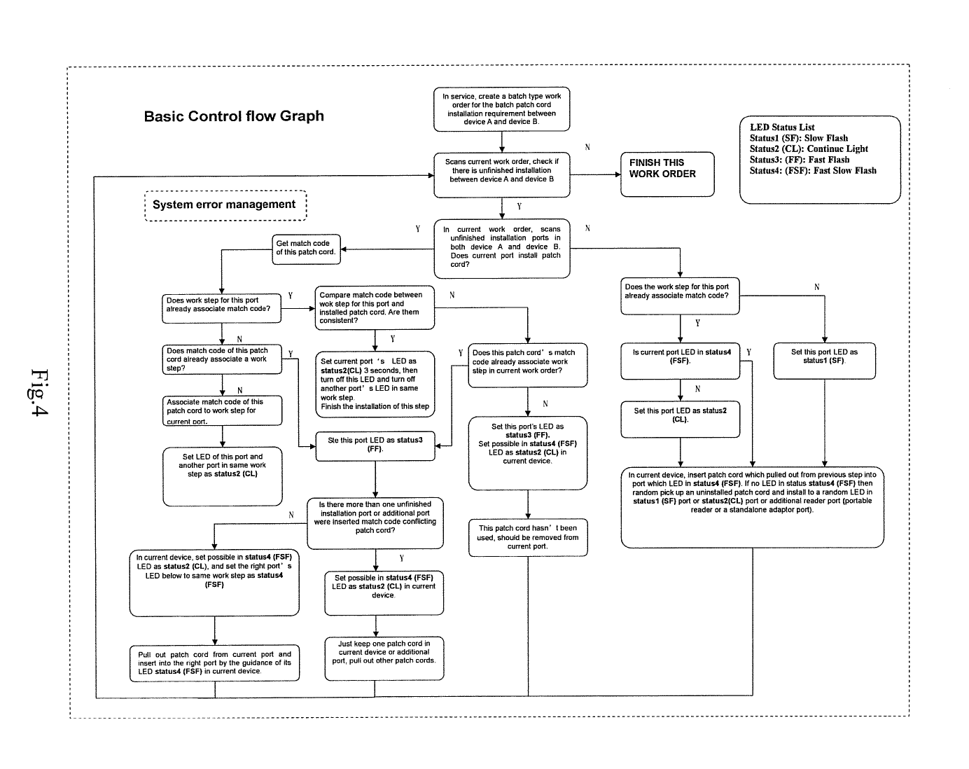

During interconnecting the objects with optical fibers, many kinds of conditions may be occurred, it is difficult to describe all kinds of conditions by examples. Hereafter, it will describe such many kinds of conditions with reference to FIG. 4.

FIG. 4 is a basic control flow chart to build up a correct fiber interconnection among the ports of a pair of objects A, B, in which many kinds of error management flows are shown.

As shown in FIG. 4, the pair of equipments A and B will be interconnected with optical fibers. LED lamps are used as the indicators to guide the operators to install and maintain the equipments and alert many kinds of errors. The operators can correctly finish the installation of the equipments under the indications of the LED lamps. The optical fibers mentioned herein each has RFID tags at both ends thereof

1. As shown in FIG. 4, the server management device builds up a task form comprising a correct one-to-one correlation among the ports of the pair of equipments A and B to be interconnected.

2. The server management device controls the LED lamps of the ports of the pair of equipments A and B to switch into the first indication state SF, then the one operator at the equipment A and the other operator at the equipment B simultaneously insert the ends of the optical fibers into the ports having the first indication state SF of the pair of equipments A and B, and the server management device repeatedly scans the connection state of the respective ports of the equipments A and B, and determines whether the current scanned port has been connected with the optical fiber and whether the current scanned port has been correlated to the matching code of the optical fiber.

3. If the current port is connected with the optical fiber, the server management device obtains the matching code of the current optical fiber, and performs the following operations:
3.1 if the current port is not correlated to any matching code and the current optical fiber is not correlated to any port, the server management device correlates the current optical fiber to the current port, and switches the LED lamps of the current port and another port to be correctly connected to the current port into the second indication state CL;
3.2 if the current port is not correlated to any matching code and the current optical fiber is correlated to another port, the server management device switches the LED lamp of the current port into the third indication state FF, and switches the LED lamp of the another port into the fourth indication state FSF, so as to guide the operator to correctly inert the optical fiber into the another port;
3.3 if the current port is correlated to a matching code and the matching code is that of the current optical fiber, that is, the current optical fiber is correctly inserted into the current port, the server management device switches the LED lamp of the current port into the second indication state CL, and turns off the LED lamps of the pair of ports that have been correctly connected after a predetermined period, for example, 3 seconds;
3.4 if the current port is correlated to a matching code and the matching code is not that of the current optical fiber, that is, the current optical fiber is incorrectly inserted into the current port, the server management device switches the LED lamp of the current port into the third indication state FF, and switches a LED lamp of the fourth indication state FSF into the second indication state CL; in this case, if the matching code of the current optical fiber is not correlated to any port, the current optical fiber should be removed;
3.5 if the current port is correlated to a matching code and the matching code is not that of the current optical fiber, that is, the current optical fiber is incorrectly inserted into the current port, the server management device switches the LED lamp of the current port into the third indication state FF, and switches a LED lamp of the fourth indication state FSF into the second indication state CL; in this case, if the matching code of the current optical fiber is correlated to another port, the server management device switches the LED lamp of the another port into the fourth indication state FSF to guide the operator to inert the current optical fiber into the another port.

4. If the current port is not connected with the optical fiber, the server management device performs the following operations:
4.1 if the current port is not correlated to any matching code, the server management device switches the LED lamp of the current port into the first indication state;
4.2 if the current port is correlated to a matching code and the LED lamp of the current port is in the fourth indication state FSF, the server management device keeps the fourth indication state FSF of the LED lamp of the current port, and if the LED lamp of the current port is not in the fourth indication state FSF, the server management device switches the LED lamp of the current port into the second indication state CL.

In this case, the operator may insert the optical fiber, which is previously pulled out from an error port, into the port having the fourth indication state, if there is no the port having the fourth indication state, the operator may take any of the optical fibers to be connected and randomly insert the optical fiber into any one port having the first indication state, if there is no the port having the first indication state, the operator may insert the optical fiber into any one port having the second indication state.

5. One end of the optical fiber is firstly inserted into any one port having the first indication state in the manner of blind plug installation, and the other end of the optical fiber is inserted into any one port having the second indication state, and the server management device can switch the LED lamp of the correct port correlated to the matching code of the optical fiber into the fourth indication state.

6. If a new optical fiber is inserted into a new port in case where an optical fibers is incorrectly inserted to a port and is not pulled out of the incorrect port, the server management device switches the LED lamp of the new port into the third indication state FF and does not switch any LED lamp into the fourth indication state, at this time, the operator has to remove the incorrectly inserted optical fiber until there is only one optical fiber left. When there is only one incorrectly inserted optical fiber is left, the server management device switches LED lamp of the correct port correlated to the left one into the fourth indication state to guide the installation. During installation, the optical fiber not correlated to any port should be inserted into the port having the first indication state until there is no the port having the first indication state. After there is no the port having the first indication state, the operator should not take any new optical fiber and insert any new optical fiber into the port because the number of current used optical fibers is enough for the ports of the equipments to be interconnected. If all optical fibers have been correctly inserted into the ports, and there still exists the port having the first indication state, the operator should take or add new optical fibers because the number of current used optical fibers is not enough for the ports of the equipments to be interconnected.

7. LED status list (list)

State 1 (SF), exhibited as the slow flashing state, means that the corresponding port neither is correlated to the matching code of the optical fiber nor connected with the optical fiber;

Status 2 (CL), exhibited as the normally lighting state, means that the corresponding port is correlated to the matching code of the optical fiber;

State 3 (FF), exhibited as the quick flashing state, means that a mistaken connection is occurred and that the corresponding port is incorrectly connected with the optical fiber;

State 4 (F SF), exhibited as the quick-slow flashing state, means that the optical fiber which is pulled out of the port having the quick flashing state should be inserted into the port having the quick-slow flashing state.

In the above exemplary embodiments of the present invention, the system for interconnecting the equipments uses the optical fibers with RFID tags. The RFID tags of each of the optical fibers contain an unique and the same matching code. In this way, the readers at respective ports of the equipments can obtain the matching code from the RFID tag and identify the optical fiber based on the obtained matching code.

Although the RFID tag is used as the tag of the optical fiber in the above embodiments of the present invention, the present invention is not limited to this, the tag of the optical fiber may be taken the form of a bar code, a digital mark, an image mark, or any other suitable tag adhered or printed to the ends of optical fiber as long as these tags can be automatically read by an electrical apparatus.

Alternatively, in another exemplary embodiment, a chip or a circuit may be used as the tag of the optical fiber, and the chip or a circuit may be disposed inside the end of the optical fiber, and the electronic identification device (EDI) for the chip or the circuit may be a conductive contact interface, instead of the RFID reader antenna of FIG. 1.

The system of the present invention is not only adapted to the fiber interconnection between two equipments, but also adapted to the fiber interconnection between three or more equipments. Furthermore, the system of the present invention is also adapted to the fiber interconnection between different regions or modules of a single equipment.

In the above exemplary embodiments of the present invention, the quick flashing state, the slow flashing state, the quick-slow flashing state, the normally lighting state and the light out state of the LED lamp are used to guide the connection of the optical fiber, alert the misconnection of the optical fiber, indicate the operation state, and so on. But it should be appreciated for those skilled in this art that the indication state of the LED lamp may comprise any other suitable indication state, for example, various color indication states of color-changing LED lamp.

Although the LED lamp is used as the indicator in the above exemplary embodiments of the present invention, but the present invention is not limited to this, the indicator may be a display, a sounder, a vibrator, or combination thereof. Correspondingly, the operator can correctly insert the optical fiber into the port under visual, auditory or tactile guidance.

According to the above exemplary embodiments of the present invention, it can quickly connect the optical fibers between equipments or different regions or modules of the same equipment regardless of the distance between the equipments and can avoid the misconnection of the optical fibers. Accordingly, the system according to the above embodiments of the present invention can achieve the advantage that the operator can correctly insert the optical fibers into the respective ports of the equipments in the field only under the guidance of indications of the LED lamps without a need to look up a fiber-port distribution table and identify serial numbers of optical fibers and ports in advance. With the system and the method of the present invention, the ports of the equipments can be quickly and correctly interconnected in a manner of blind plug installation.

Furthermore, the system according to the above embodiments of the present invention can automatically find the misconnection of the optical fiber in time and guide the operator to insert the misconnected optical fiber to the correct port again.

Also, the system according to the above embodiments of the present invention can achieve quick interconnection between equipments with the optical fibers, especially, in quantities, and has the ability of preventing error or displaying error.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is,:

1. A system for interconnecting at least a pair of objects with optical fibers, comprising:
optical fibers each having a first end provided with a first tag and a second end provided with a second tag, wherein the first and second tags of each optical fiber contain an unique and the same matching code or different but correlated matching codes, the optical fibers each is disposed between a pair of objects with the first end near one of the pair of objects and the second end near the other of the pair of objects, the first end of the optical fiber is to be inserted into the port of the one object, and the second end of the optical fiber is to be inserted into the port of the other object;
a plurality of readers provided at a plurality of ports (A1, A2, . . . , AM) of each object (A, B, . . . , X) to be connected by the optical fibers, respectively, for reading the matching codes from the tags of the optical fibers inserted into respective ports;
a plurality of indicators (LED A1, LED A2, . . . , LED AM) provided at the plurality of ports of each object (A, B, . . . , X) to be connected by the optical fibers, respectively, for indicating states of respective ports; and
a server management device for processing data read from the objects and controlling the states of the indicators, wherein
before inserting the optical fiber, the server management device builds up a correct one-to-one correlation among the ports of the pair of objects (A, B) to be interconnected and controls all ports of the pair of objects (A, B) to switch into a first indication state;
operations of randomly inserting the ends of the optical fibers into the ports of the pair of objects to be interconnected are performed simultaneously at the pair of objects,
the optical fiber is firstly randomly inserted into the port having the first indication state, and the server management device obtains the matching code of the tag of the current inserted optical fiber through the reader corresponding to the current connected port, correlates the current obtained matching code to the current connected port and another port to be correctly connected with the current connected port, and controls the indicators of the current connected port and the another port correlated to the current obtained matching code to switch into a second indication state,
when the pair of objects neither have the port having the first indication state, the optical fiber is randomly inserted into the port having the second indication state, and the server management device obtains the matching code of the tag of the current inserted optical fiber through the reader corresponding to the current connected port, and determines whether the current connected port is the port correlated to the matching code of the current inserted optical fiber,
if the current connected port is not the port correlated to the matching code of the current inserted fiber, the server management device controls the indicator of the current connected port to switch into a third indication state, and controls the indicator of the port correlated to the matching code of the current inserted optical fiber to switch into a fourth indication state, so as to guide an operator to pull the current inserted optical fiber out of the current connected port and insert the current pulled optical fiber into the port having the fourth indication state,
when the second end of the optical fiber whose first end has been inserted into the port having the first indication state of the one object is inserted into the port having the first indication state of the other object, the server management device obtains the matching code of the tag of the second end of the current inserted optical fiber through the reader corresponding to the current connected port of the other object, and
if the server management device determines that the matching code of the current inserted optical fiber has been correlated to another port of the other object and the current connected port of the other object has not been correlated to any matching code of any optical fiber, then the server management device controls the indicator of the current connected port of the other object to switch into the third indication state, and controls the indicator of the port of the other object correlated to the matching code of the current inserted optical fiber to switch into the fourth indication state, so as to guide the operator to pull the current inserted fiber out of the current connected port of the other object and insert the current pulled optical fiber into the port having the fourth indication state of the other object, and controls the indicator of the port, from which the optical fiber has been just pulled, to switch into the first indication state again,
the first, second, third and fourth indication states are different from each other.

2. The system according to claim 1, wherein
when the second end of the optical fiber whose first end has been inserted into the port of the one object is correctly inserted into the port of the other object correlated to the matching code of the current inserted optical fiber, the server management device controls the current connected port of the other object to switch into the second indication state, and turns off the indicators of the pair of current ports correctly connected after a predetermined period.

3. The system according to claim 1, wherein
in a case where a first end of a current optical fiber has been inserted into a third object which does not belong to any one of the pair of objects to be interconnected, when a second end of the current optical fiber is randomly inserted into one of the ports of the other object of the pair of objects to be interconnected, the server management device controls the indicator of the current port of the other object to switch into the third indication state, and controls indicators of all empty ports of the other object to switch into the second indication state, so as to notice the operator that the current optical fiber has been inserted into the third object, that does not belong to any one of the pair of objects to be interconnected, and should be removed from the other object of the pair of objects to be interconnected.

4. The system according to claim 1, wherein
when two or more fibers are incorrectly inserted into two or more ports of one of the pair of objects to be connected, the server management device controls indicators of the two or more ports of the object to switch into a third indication state, and controls all empty ports of the object to switch into the second indication state, so as to notice the operator to remove the two or more fibers from the object until only one of the two or more fibers is left, and
when only one of the two or more fibers is left, the server management device controls the indicator of the port of the object correlated to the matching code of the left one fiber to switch into the fourth indication state, so as to guide the operator to correctly insert the left one fiber into the port of the object having the fourth indication state.

5. The system according to claim 1, wherein the indicator comprises a lamp, a display, a sounder, a vibrator, or combination thereof.

6. The system according to claim 5, wherein the indicator comprises a LED lamp.

7. The system according to claim 6, wherein
the first indication state is a state selected from a slow flashing state, a quick flashing state having a frequency higher than that of the slow flashing state, a quick-slow flashing state having a frequency equal to that of the slow flashing state in one half period and a frequency equal to that of the quick flashing state in the other half period, and a normally lighting state;
the second indication state is a state, different from the first indication state, selected from the slow flashing state, the quick flashing state, the quick-slow flashing state, and the normally lighting state;
the third indication state is a state, different from the first and second indication states, selected from the slow flashing state, the quick flashing state, the quick-slow flashing state, and the normally lighting state; and
the fourth indication state is a state, different from the first, second and third indication states, selected from the slow flashing state, the quick flashing state, the quick-slow flashing state, and the normally lighting state.

8. The system according to claim 7, wherein
the first indication state is the slow flashing state, the second indication state is the normally lighting state, the third indication state is the quick flashing state, and the fourth indication state is the quick-slow flashing state.

9. The system according to claim 1, wherein the pair of objects to be interconnected are disposed such that a single operator cannot simultaneously perform the fiber insertion operation for the pair of objects.

10. The system according to claim 9, wherein the pair of objects to be interconnected are disposed such that the single operator at one of the pair of objects cannot see or access the other one of the pair of objects.

11. The system according to claim 10, wherein the pair of objects are disposed in different locations of a room, different rooms, different floors, different buildings, different residential areas, different streets, different cities or different countries.

12. The system according to claim 1, wherein each of tags further contains a unique identification code for differentiating respective tags.

13. The system according to claim 1, wherein the server management device comprises only a central processing unit communicated with all objects to be interconnected.

14. The system according to claim 1, wherein the server management device comprising:
a central processing unit; and
a single-stage or a multi-stage secondary processing unit communicated between the central processing unit and the respective objects, for monitoring the connection state of the ports and controlling the indication state of the indicators of the respective objects.

15. The system according to claim 1, wherein the tag comprises a RFID tag.

16. The system according to claim 1, wherein the objects comprise different equipments or different regions or modules on single equipment.

17. The system according to claim 16, wherein the equipment comprises an optical fiber distributing equipment, and wherein the optical fiber comprises a distribution fiber for the optical fiber distributing equipment.

18. The system according to claim 1, wherein at least one of the ports of at least one of the objects to be connected comprises a port of a portable electronic device communicated with the server management device in real time.

19. A method for interconnecting at least a pair of objects with optical fibers, comprising:
S100: providing a system for interconnecting objects with optical fibers, the system comprising:
optical fibers each having a first end provided with a first tag and a second end provided with a second tag, wherein the first and second tags of each optical fiber contain an unique and the same matching code or different but correlated matching codes, the optical fibers each is disposed between a pair of objects with the first end near one of the pair of objects and the second end near the other of the pair of objects, the first end of the optical fiber is to be inserted into the port of the one object, and the second end of the optical fiber is to be inserted into the port of the other object;
a plurality of readers provided at a plurality of ports (A1, A2, . . . , AM) of each object (A, B, . . . , X) to be connected by the optical fibers, respectively, for reading the matching codes from the tags of the optical fibers inserted into respective ports;
a plurality of indicators (LED A1, LED A2, . . . , LED AM) provided at the plurality of ports of each object (A, B, . . . , X) to be connected by the optical fibers, respectively, for indicating states of respective ports; and
a server management device for processing data read from the objects and controlling the states of the indicators;
S200: before inserting the optical fiber, the server management device builds up a correct one-to-one correlation among the ports of the pair of objects (A, B) to be interconnected and controls all ports of the pair of objects (A, B) to switch into a first indication state;
S300: at the pair of objects, simultaneously performing operations of randomly inserting the ends of the optical fibers into the ports of the pair of objects to be interconnected, wherein
the optical fiber is firstly randomly inserted into the port having the first indication state, and the server management device obtains the matching code of the tag of the current inserted optical fiber through the reader corresponding to the current connected port, correlates the current obtained matching code to the current connected port and another port to be correctly connected with the current connected port, and controls the indicators of the current connected port and the another port correlated to the current obtained matching code to switch into a second indication state,
when the pair of objects neither have the port having the first indication state, the optical fiber is randomly inserted into the port having the second indication state, and the server management device obtains the matching code of the tag of the current inserted optical fiber through the reader corresponding to the current connected port, and determines whether the current connected port is the port correlated to the matching code of the current inserted optical fiber,
if the current connected port is not the port correlated to the matching code of the current inserted fiber, the server management device controls the indicator of the current connected port to switch into a third indication state, and controls the indicator of the port correlated to the matching code of the current inserted optical fiber to switch into a fourth indication state, so as to guide an operator to pull the current inserted optical fiber out of the current connected port and insert the current pulled optical fiber into the port having the fourth indication state,
when the second end of the optical fiber whose first end has been inserted into the port having the first indication state of the one object is inserted into the port having the first indication state of the other object, the server management device obtains the matching code of the tag of the second end of the current inserted optical fiber through the reader corresponding to the current connected port of the other object, and
if the server management device determines that the matching code of the current inserted optical fiber has been correlated to another port of the other object and the current connected port of the other object has not been correlated to any matching code of any optical fiber, then the server management device controls the indicator of the current connected port of the other object to switch into the third indication state, and controls the indicator of the port of the other object correlated to the matching code of the current inserted optical fiber to switch into the fourth indication state, so as to guide the operator to pull the current inserted fiber out of the current connected port of the other object and insert the current pulled optical fiber into the port having the fourth indication state of the other object, and controls the indicator of the port, from which the optical fiber has been just pulled, to switch into the first indication state again, and
the first, second, third and fourth indication states are different from each other.

20. The method according to claim 19, wherein
when the second end of the optical fiber whose first end has been inserted into the port of the one object is correctly inserted into the port of the other object correlated to the matching code of the current inserted optical fiber, the server management device controls the current connected port of the other object to switch into the second indication state, and turns off the indicators of the pair of current ports correctly connected after a predetermined period.

21. The method according to claim 19, wherein
in a case where a first end of a current optical fiber has been inserted into a third object which does not belong to any one of the pair of objects to be interconnected, when a second end of the current optical fiber is randomly inserted into one of the ports of the other object of the pair of objects to be interconnected, the server management device controls the indicator of the current port of the other object to switch into the third indication state, and controls indicators of all empty ports of the other object to switch into the second indication state, so as to notice the operator that the current optical fiber has been inserted into the third object, that does not belong to any one of the pair of objects to be interconnected, and should be removed from the other object of the pair of objects to be interconnected.

22. The method according to claim 19, wherein
when two or more fibers are incorrectly inserted into two or more ports of one of the pair of objects to be connected, the server management device controls indicators of the two or more ports of the object to switch into a third indication state, and controls all empty ports of the object to switch into the second indication state, so as to notice the operator to remove the two or more fibers from the object until only one of the two or more fibers is left, and
when only one of the two or more fibers is left, the server management device controls the indicator of the port of the object correlated to the matching code of the left one fiber to switch into the fourth indication state, so as to guide the operator to correctly insert the left one fiber into the port of the object having the fourth indication state.

23. The method according to claim 19, wherein the indicator comprises a lamp, a display, a sounder, a vibrator, or combination thereof.

24. The method according to claim 23, wherein the indicator comprises a LED lamp.

25. The method according to claim 24, wherein
the first indication state is a state selected from a slow flashing state, a quick flashing state having a frequency higher than that of the slow flashing state, a quick-slow flashing state having a frequency equal to that of the slow flashing state in one half period and a frequency equal to that of the quick flashing state in the other half period, and a normally lighting state;
the second indication state is a state, different from the first indication state, selected from the slow flashing state, the quick flashing state, the quick-slow flashing state, and the normally lighting state;
the third indication state is a state, different from the first and second indication states, selected from the slow flashing state, the quick flashing state, the quick-slow flashing state, and the normally lighting state; and
the fourth indication state is a state, different from the first, second and third indication states, selected from the slow flashing state, the quick flashing state, the quick-slow flashing state, and the normally lighting state.

26. The method according to claim 25, wherein
the first indication state is the slow flashing state, the second indication state is the normally lighting state, the third indication state is the quick flashing state, and the fourth indication state is the quick-slow flashing state.

27. The method according to claim 19, wherein the pair of obj ects to be interconnected are disposed such that a single operator cannot simultaneously perform the fiber insertion operation for the pair of objects.

28. The method according to claim 27, wherein the pair of objects to be interconnected are disposed such that the single operator at one of the pair of objects cannot see or access the other one of the pair of objects.

29. The method according to claim 28, wherein the pair of objects are disposed in different locations of a room, different rooms, different floors, different buildings, different residential areas, different streets, different cities or different countries.

30. The method according to claim 19, wherein each of tags further contains a unique identification code for differentiating respective tags.

31. The method according to claim 19, wherein the server management device comprises only a central processing unit communicated with all objects to be interconnected.

32. The method according to claim 19, wherein the server management device comprising:
a central processing unit; and
a single-stage or a multi-stage secondary processing unit communicated between the central processing unit and the respective objects, for monitoring the connection state of the ports and controlling the indication state of the indicators of the respective objects.

33. The method according to claim 19, wherein the tag comprises a RFID tag.

34. The method according to claim 19, wherein the objects comprise different equipments or different regions or modules on single equipment.

35. The method according to claim 34, wherein the equipment comprises an optical fiber distributing equipment, and wherein the optical fiber comprises a distribution fiber for the optical fiber distributing equipment.

36. The method according to claim 19, wherein at least one of the ports of at least one of the objects to be connected comprises a port of a portable electronic device communicated with the server management device in real time.
